(19) United States
(12) Patent Application Publication
(10) Pub. No.: US 2026/0001072 A1
(43) Pub. Date: Jan. 1, 2026

(54) Methods, Systems, and Devices for Electrowetting Analysis

(71) Applicant: IDEXX Laboratories, Inc., Westbrook, ME (US)

(72) Inventor: Wayne Antony Bell, Westbrook, ME (US)

(21) Appl. No.: 19/251,358

(22) Filed: Jun. 26, 2025

Related U.S. Application Data
(60) Provisional application No. 63/665,755, filed on Jun. 28, 2024.

(51) Int. Cl. B01L 3/00; G01N 27/447

(52) U.S. Cl. CPC B01L 3/502715; G01N 27/44756; B01L 2200/04; B01L 2200/0647; B01L 2300/0654; B01L 2400/0427

(57) ABSTRACT

A method for analyzing a plurality of particles of a droplet on an optical read window of a cartridge is disclosed. The method includes: (i) transporting, by applying a first electrical current to a first set of electrodes of the cartridge, the droplet on a first surface of the cartridge, wherein the first set of electrodes is configured to transport the droplet on the first surface of the cartridge along a path; (ii) manipulating, by applying a second electrical current to a second set of electrodes of the cartridge, the droplet on a second surface of the cartridge, wherein the second surface comprises the optical read window, and wherein the second set of electrodes circumscribes the optical read window; and (iii) analyzing the droplet while the droplet is manipulated on the second surface of the cartridge.

### RELATED APPLICATION

This application claims priority to U.S. Provisional Application No. 63/665,755 filed Jun. 28, 2024 which is incorporated herein by reference in its entirety.

### FIELD OF THE DISCLOSURE

The present disclosure involves systems and methods for dispersing a plurality of particles of a droplet on a surface of a cartridge. Namely, devices and methods of the disclosure transport and/or manipulate the droplet and/or the plurality of particles on a surface of the cartridge to ensure that the plurality of particles are evenly dispersed throughout the droplet and that any unwanted physical interactions between any two or more particles of the plurality of particles (e.g., clumping) is minimized. In a further aspect, e.g. to improve the imaging and/or other analytical protocols, one or more surfaces of the cartridge (e.g., one or more analysis locations) may contain transparent and/or semi-transparent materials. By dispersing the particles throughout the droplet and/or providing a transparent or semi-transparent surface, any analysis of the droplet and/or components thereof (e.g., the plurality of particles) may be improved.

### BACKGROUND

Assays (including immunoassays) and other analytical evaluations (e.g., polymerase chain reaction (PCR) tests) can be conducted on one or more portions of a sample utilizing a variety of different methods, including by utilizing a plurality of particles (e.g., paramagnetic, bar-coded beads) and other components of a droplet of the solution containing the sample to assist in performing the assays and other analytical evaluations.

Conventionally, these assays and analytical evaluations have been conducted on preconfigured and prefabricated testing platforms. One such platform includes preconfigured cartridges that utilize a plurality of electrodes to transport individual droplets of a liquid on a surface of the cartridge along one or more paths defined by the plurality of electrodes on one or more surfaces of one or more materials, including a printed circuit board (PCB), semiconductor photolithography, conductive patterning on glass, conductive patterning on ceramic, and/or conductive patterning on plastic, among other possibilities. Such techniques are often referred to as electrowetting on dielectric (“EWOD”).

In some examples, a plurality of particles (e.g., paramagnetic, bar-coded beads), can be suspended within a solution on the surface of an EWOD cartridge that can be used for testing and identification of components in the solution and/or a portion thereof (e.g., a particular type of paramagnetic, bar-coded bead). To increase the accuracy of assay test results, it is desirable to, prior to testing, ensure that the plurality of particles (e.g., paramagnetic, bar-coded beads) are properly dispersed throughout the solution and properly transported and/or manipulated (e.g., immobilized) during the mixing of the components of the assay, as well as during readings of the resultant solution.

When a sample resides in a prepared droplet of solution for too long prior to testing, the homogeneity and number of particles throughout the area to be imaged and/or otherwise analyzed (e.g., the read area) may be inconsistent and any resultant analysis of the droplet (or components therein) may be inaccurate. Further, this inconsistency may be due, at least in part, to the particles becoming less homogenized and/or dispersed throughout the droplet (e.g., by settling to the bottom and/or edges of the droplet, clumping together or both, among other potential issues), as well as one or more issues that involve lighting and/or other factors that denigrate the quality and/or consistency of imaging and/or other analytical protocols of the particles. Accordingly, preparations and/or imaging of the droplet and the components thereof are subject to variability between testing runs and/or operators and, thus, degrade the accuracy and precision of any associated testing results (e.g., assay results).

### SUMMARY

In an example, a cartridge comprising a plurality of electrodes comprising a first set of electrodes and a second set of electrodes is described. The cartridge further comprises a first surface for transporting, by applying a first electrical current to the first set of electrodes of the cartridge, a droplet on the surface of the cartridge, wherein the first set of electrodes is configured to transport the droplet on the first surface of the cartridge along a path, and wherein the droplet comprises a plurality of particles. The cartridge further comprises a second surface for manipulating, by applying a second electrical current to the second set of electrodes of the cartridge, the droplet on the second surface of the cartridge, wherein the second surface comprises an optical read window, and wherein the second set of electrodes circumscribes the optical read window.

In another example, an example method for analyzing a plurality of particles of a droplet on an optical read window of a cartridge is described. The method comprises transporting, by applying a first electrical current to a first set of electrodes of the cartridge, the droplet on a first surface of the cartridge, wherein the first set of electrodes is configured to transport the droplet on the first surface of the cartridge along a path, and wherein the droplet comprises the plurality of particles. The method further comprises manipulating, by applying a second electrical current to a second set of electrodes of the cartridge, the droplet on a second surface of the cartridge, wherein the second surface comprises the optical read window, and wherein the second set of electrodes circumscribes the optical read window. The method further comprises analyzing the droplet while the droplet is manipulated on the second surface of the cartridge.

In another example, a non-transitory computer-readable medium is described, having stored thereon program instructions that, upon execution by a controller cause a controller to perform a set of operations. The set of operations comprises (i) transporting, by applying a first electrical current to a first set of electrodes of a cartridge, a droplet on the surface of the cartridge a droplet on a first surface of the cartridge, wherein the first set of electrodes is configured to transport the droplet on the first surface of the cartridge along a path, and wherein the droplet comprises a plurality of particles; (ii) manipulating, by applying a second electrical current to a second set of electrodes of the cartridge, the droplet on the surface of the cartridge, the droplet on the second surface of the cartridge, wherein the second surface comprises an optical read window, and wherein the second set of electrodes circumscribes the optical read window; and (iii) analyzing the droplet while the droplet is manipulated on the second surface of the cartridge.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a cartridge, according to an example embodiment.

FIG. 2B illustrates a magnified view of one or more components of the cartridge of FIG. 2A, according to an example embodiment.

FIG. 2C illustrates a cross-sectional view of a section of the cartridge of FIGS. 2A-2B, according to an example embodiment.

FIG. 3A illustrates a cartridge, according to an example embodiment.

FIG. 3B illustrates a magnified view of one or more components of the cartridge of FIG. 3A, according to an example embodiment.

FIG. 3C illustrates a cross-sectional view of a section of the cartridge of FIGS. 3A-3B, according to an example embodiment.

FIG. 3D illustrates a sample image of one or more components of the cartridge of FIGS. 3A-3C, according to an example embodiment.

FIG. 4 illustrates a magnified view of an alternative example embodiment of the cartridge of FIGS. 3A-3D, according to an example embodiment.

FIG. 5 illustrates a computing system configured for use with an imaging device and a mobile computing device, according to an example embodiment.

FIG. 6 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Within examples, the disclosure is directed to devices and methods for transporting and manipulating droplets of a solution containing samples and a plurality of particles (e.g., one or more types of paramagnetic, bar-coded beads) containing one or more identifying features (such as a unique bar code, a responsive wavelength (e.g., in PCR testing), a color, a shape, an alphanumeric symbol, and/or the like). These particles include one or more of the following: microbeads, microparticles, micropellets, microwafers, microparticles containing one or more identifying features (such as a bar code, a responsive wavelength (e.g., in PCR testing), a color, a shape, an alphanumeric symbol, and/or the like), paramagnetic microparticles, paramagnetic microparticles containing one or more bar codes, and/or beads containing one or more bar codes. Moreover, the particles may be magnetic or paramagnetic. Particles suitable for use in the disclosure are capable of attachment to other substances such as derivatives, linker molecules, proteins, nucleic acids, or combinations thereof. The capability of the particles to be attached to other substances can result from the particle material as well as from any further surface modifications or functionalization of the particle. The particles can be functionalized or be capable of becoming functionalized in order to covalently or non-covalently attach proteins, nucleic acids, linker molecules or derivatives as described herein.

For example, the surface of these particles (e.g., paramagnetic, bar-coded beads), can be modified or functionalized with amine, biotin, streptavidin, avidin, protein A, sulfhydryl, hydroxyl and carboxyl. These particles may be spherical or other shapes, may be light transmissive and may be digitally coded such as for example, by an image that provides for high contrast and high signal-to-noise optical detection to facilitate identification of the bead. To the extent an image is present, the image may be implemented by a physical structure having a pattern that is partially substantially transmissive (e.g., transparent, translucent, and/or pervious to light), and partially substantially opaque (e.g., reflective and/or absorptive to light) to light. The pattern of transmitted light is determined (e.g., by scanning or imaging), and the code represented by the image on the coded bead can be decoded. Various code patterns, such as circular, square, or other geometrical shapes, can be designed as long as they can be recognized by an optical decoder. Examples of these one or more types of particles may be found at: U.S. Pat. Nos. 7,745,091, 8,148,139, and 8,614,852.

Additionally or alternatively, these particles (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these particles also comprise one or more specific shapes, dimensions, and/or configurations and may be modified for one or more specific uses. For example, these particles (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

The particles of the disclosure may be used in various homogenous, sandwich, competitive, or non-competitive assay formats to generate a signal that is related to the presence or amount of an analyte in a test sample. The term “analyte,” as used herein, generally refers to the substance, or set of substances in a sample that are detected and/or measured, either directly or indirectly. In various aspects, the assays of the disclosure include sandwich immunoassays that capture an analyte in a sample between a binding member (e.g., antibody) attached to the particles and a second binding member for the analyte that is associated with a label. In another example embodiment, the binding member on the particles may be an antigen (e.g., protein) that binds an antibody of interest in a patient sample in order to capture the antibody on the particle. The presence of the antibody can then be detected with a label conjugated to a second binding member specific for an antibody. The second binding member attached to the label may be the antigen conjugated to the label or the binding member may itself be an antibody (e.g., anti-species antibody) that is conjugated to the label. In example embodiments, these characteristics may be referred to herein as a “unique identifying feature” and/or “parameter” of the particles and/or of the droplet in which the particles reside. Other examples are possible.

For example, the particles may be imaged and/or otherwise analyzed while the particles are illuminated or partially illuminated to better identify a “unique identifying feature” and/or “parameter” of the particles under one or more appropriate lighting sources (e.g., a fluorescent, brightfield, and/or ultraviolet lighting). In some examples, this light illumination may be undertaken via backlighting the particles (e.g., via shining a fluorescent and/or brightfield light source on the opposing side of an optically transparent material on which one or more of the particles are located) and/or sidelighting the particles (e.g., via shining a fluorescent and/or brightfield light source on one or more sides of one or more locations of one or more of the particles), among other possibilities. For example, the particles may also bind to a fluorescent tag or label, which may present a “unique identifying feature” and/or “parameter” of the particles to which the fluorescent tag or label might bind and emit one or more responsive signals (e.g., a light signal) under one or more appropriate excitation stimuli (e.g., a fluorescent, brightfield, and/or ultraviolet lighting).

In another example embodiment, the testing protocols of the disclosure are assays, including competitive immunoassays for detection of antibody in the sample. A competitive immunoassay may be carried out in the following illustrative manner. A sample, e.g. from an animal's body fluid, potentially containing an antibody of interest that is specific for an antigen, is contacted with the antigen attached to the particles and with the anti-antigen antibody conjugated to a detectable label. The antibody of interest, present in the sample, competes with the antibody conjugated to a detectable label for binding with the antigen attached to the particles. The amount of the label associated with the particles can then be determined after separating unbound antibody and the label. The signal obtained is inversely related to the amount of antibody of interest present in the sample.

In an alternative example embodiment of a sample, an animal's body fluid, potentially containing an analyte, is contacted with the analyte conjugated to a detectable label and with an anti-analyte antibody attached to the particles. The antigen in the sample competes with analyte conjugated to the label for binding to the antibody attached to the particles. The amount of the label associated with the particles can then be determined after separating unbound antigen and the label. The signal obtained is inversely related to the amount of analyte present in the sample.

Antibodies, antigens, and other binding members may be attached to the particles or to the label directly via covalent binding with or without a linker or may be attached through a separate pair of binding members as is well known (e.g., biotin:streptavidin, digoxigenin:anti-digoxiginen). In addition, while the examples herein reflect the use of immunoassays, the paramagnetic, bar-coded beads and/or particles and methods of the disclosure may be used in other receptor binding assays, including nucleic acid hybridization assays, that rely on immobilization of one or more assay components to a solid phase.

Assays using these solutions are often conducted after a series of agitation, assembly, and/or mixing events. In practice, these particles (particularly if they are paramagnetic, bar-coded beads) may bind together in the solution (often referred to as “clumping”) or bind and/or settle on the sides of the solution and/or a surface or container with which the solution is in contact. This binding and/or clumping may result in an inconsistent dispersion of the particles (e.g., paramagnetic, bar-coded beads and/or particles) in the solution. When these particles clump together, they may not be accurately identified or accounted for in the assay.

For example, to help address these issues, a cartridge may utilize one or more electrodes that facilitate transportation of individual droplets of a liquid on a surface of the cartridge and/or one or more components thereof. To do so, in one example embodiment, the cartridge surface may comprise dielectric materials that transport individual droplets along one or more paths defined by the one or more electrodes on one or more surfaces of one or more materials, including (PCB), semiconductor photolithography, conductive patterning on glass, conductive patterning on ceramic, and/or conductive patterning on plastic, among other possibilities. In example embodiments, the dielectric materials may comprise a hydrophobic material, layer, and/or coating disposed on the surface of the PCB and/or one or more electrodes, the combination of which is referred to herein as the “dielectric surface” and/or a “path” or “paths” along the dielectric surface.

In some embodiments, transportation of the droplets on the cartridge surface can be controlled by a controller and/or other computing devices to create a programmable fluidic path which can be used in number of ways (e.g., to facilitate the performance of an assay and/or immunoassay). Further, because the fluidic movements of the droplets are controlled by a controller and/or other computing device, and programmable, assay protocols and subparts thereof can be finely controlled to meet the needs of the solution mixing, particle assembly, and/or assay, among other parameters.

For example, in some example embodiments, the transportation of the droplets and/or or components thereof may be transported and/or otherwise controlled by one or more sets of a plurality of electrodes that receive an electrical current that mobilize the droplet along one or more specific fluidic paths on the surface of the cartridge (e.g., a dielectric surface of the cartridge). In some examples, a set of electrodes may include a single electrode. In some examples, a set of electrodes may include two or more electrodes. Other examples are possible.

In some examples, one or more electrodes may receive an alternating electrical current (“AC”) at a particular frequency during transportation of the droplet. For example, this particular frequency may be one or more of a variety of frequencies from about 10 hertz to about 100 hertz, for example about 10, 20, 30, 40 50, 60, 70, 80, 90 or 100 hertz. In some examples, the one or more electrodes may receive an alternating electrical current at a particular voltage during transportation of the droplet. For example, this particular voltage may be one or more of a variety of voltages from about 10 volts to about 1000 volts, for example about 10, 50, 100, 200, 300, 400 500, 600, 700, 800, 900, or 1000 volts. Other examples are possible.

For example, in some embodiments, the droplets and/or or components thereof may be transported at a particular transport speed along one or more specific fluidic paths on the surface of the cartridge. In some examples, one or more electrodes may receive a particular alternating electrical current at a particular frequency (e.g., 30 hertz) that causes the droplet to be transported along the surface of the cartridge such that the droplet is moving at a particular speed (referred to herein as “transport speed”) such that the droplet does not reside in one location on the cartridge surface for more than a threshold amount of time during transportation of the droplet (referred to herein as “hold time”). For example, this threshold amount of hold time may be from about 10 milliseconds to about 1300 milliseconds, for example about 10, 20, 30, 40 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, 1100, 1110, 1120, 1130, 1140, 1150, 1160, 1170, 1180, 1190, 1200, 1210, 1220, 1230, 1240, 1250, 1260, 1270, 1280, 1290, or 1300 milliseconds. Other examples are possible.

For example, in some embodiments, the droplets and/or or components thereof may be transported along one or more specific fluidic paths on the surface of the cartridge. In some examples, the one or more sets of electrodes may cause the droplet to be transported along a first, substantially linear fluidic path on the surface of the cartridge at a first transport speed and then cause the droplet to be transported along a second, substantially linear fluidic path on the surface of the cartridge that is of a specific orientation to the first substantially linear fluidic path at a second transport speed. In example embodiments, if the droplet does not reside in one location on the cartridge surface for more than a threshold amount of time, then the kinetics of being transported along the first and/or second substantially linear fluidic paths may impart a mechanical action on the droplet and/or the components thereof during transportation of the droplet. For example, in some embodiments, if the first and second substantially linear fluidic paths are perpendicular to each other, and the transport speed of the droplet is the same or similar along each fluidic path, then the droplet and the components thereof will be imparted with a mechanical action caused by the momentum of the droplet and/or the components taking a 90 degree turn during transportation of the droplet. This mechanical action may cause, among other things, the components of the droplet (e.g., a plurality of particles in the droplet) to move and/or otherwise disperse throughout the droplet. Other examples are possible.

In some examples, one or more electrodes may cause the droplet to be transported along a first, substantially linear fluidic path on the surface of the cartridge at a first transport speed and then cause the droplet be transported along a second, non-linear fluidic path on the surface of the cartridge that is of a specific configuration and/or orientation to the first substantially linear fluidic path at a second transport speed. For example, in some embodiments, if the first substantially linear fluidic path is connected to a particularly configured second, substantially rectangular fluidic path, and the transport speed of the droplet is the same or similar along each fluidic path, then the droplet and the components thereof will be imparted with a mechanical action caused by the momentum of the droplet and/or the components during transportation of the droplet. This mechanical action may cause, among other things, the components of the droplet (e.g., a plurality of particles in the droplet) to move and/or otherwise disperse throughout the droplet. Other example non-linear paths include: substantially square paths, substantially circular paths, substantially triangular paths, substantially pentagonal paths, substantially hexagonal paths, substantially heptagonal paths, substantially octagonal paths, and substantially decagonal paths, among others. Other examples are possible.

For example, in some example embodiments, the manipulation of the droplets and/or or components thereof may be manipulated and/or otherwise controlled by one or more electrodes that receive an electrical current that manipulates (e.g., immobilizes) the droplet at one or more specific locations along the fluidic paths on the surface of the cartridge (e.g., a dielectric surface of the cartridge). In some examples, the one or more electrodes may receive a direct electrical current (“DC”) that immobilizes the droplet and/or the components thereof during testing and/or analysis.

In some examples, this manipulation (e.g., immobilization) may occur at a particular location on the cartridge. In some examples, this manipulation may occur at a testing location on the surface of the cartridge. In some examples, this testing location may be made of an optically opaque (or substantially optically opaque) material (e.g., PCB). In other examples, this testing location may include an optical read window that allows light to transmit through the material on which the droplet, plurality of particles, and/or other testing components reside during testing and/or other analytical protocols. In some examples, light may transmit through the optical read window pursuant to the optical read window containing one or more optically transparent (or substantially optically transparent) material. In some examples, the optically transparent material comprises one or more of: (i) polyethylene terephthalate (PET); (ii) polyethylene (PE); (ii) acrylic; (iv) glass; (v) polyvinyl chloride (PVC); (vi) polycarbonate (PC); (vii) silicone; and (viii) transparent rubber materials. Other examples are possible.

For example, if one or more of the materials in the optical read window have one or more physical and/or chemical characteristics that may be improved by introducing one or more additional materials, then, in some embodiments, these secondary materials may be added to the optical read window components and/or components that surround the optical read window. For example, in some embodiments, the optical read window materials may benefit from adding a stiffening materials around the optically transparent material, as the optically transparent material may not have the structural integrity and/or rigidity to provide sufficient support during testing and/or analysis. In some examples, the stiffening material comprises one or more of: (i) glass-reinforced epoxy resin laminate; (ii) polybutylene terephthalate (PBT); (iii) polyethylene terephthalate (PET); (iv) polyethylene (PE); (v) acrylic; (vi) glass; (vii) plastic; (viii) polyvinyl chloride (PVC); (ix) polycarbonate (PC); (x) metal; (xi) metal alloy; (xii) paper materials; (xiii) cardboard; (xiv) cellulose; and (xv) rubber materials. In some examples, one or more of these stiffening materials may circumscribe the optical read window to provide structural support for the optical read window, while also not interfering with the optically transparent materials of the optical read window. Other examples are possible.

In some examples, the optical read window and/or components thereof may comprise one or more shapes and/or some combination thereof, including: rectangular, substantially rectangular, square, substantially square, rounded, substantially rounded, circular, substantially circular, triangular, substantially triangular, pentagonal, substantially pentagonal, hexagonal, substantially hexagonal, heptagonal, substantially heptagonal, octagonal, substantially octagonal, decagonal, and substantially decagonal, among others. In some examples, the diameter of the optical read window will be approximately 2 millimeters in diameter, but may also range from approximately 0.5 millimeters to approximately 15 millimeters, including: 5 millimeters, 1 millimeters, 1.5 millimeters, 2.5 millimeters, 3 millimeters, 4 millimeters, 5 millimeters, 6 millimeters, 7 millimeters, 8 millimeters, 9 millimeters, 10 millimeters, 11 millimeters, 12 millimeters, 13 millimeters, 14 millimeters, and 15 millimeters, among other possibilities. In some examples, one or more electrodes may circumscribe the optical read window (e.g., circumscribe the outer perimeter of the optical read window) to provide electromechanical manipulation (e.g., immobilization) for the droplet, plurality of particles, and/or other components located on a surface of the optical read window, while also not interfering with the optically transparent materials of the optical read window. Other examples are possible.

In some examples, particularly if the droplet and/or the components thereof have magnetic or paramagnetic properties, if one or more electrodes receive a direct electrical current, then the droplet and/or the components may align and/or otherwise be oriented in one or more particular orientations during testing and/or analysis (e.g., due to the DC creating a magnetic field in one or more particular directions). In some examples, the one or more sets of electrodes may also receive an alternating electrical current (“AC”) at a particular frequency during manipulation of the droplet. For example, this particular frequency may be one or more of a variety of frequencies from about 10 hertz to about 100 hertz, for example about 10, 20, 30, 40 50, 60, 70, 80, 90 or 100 hertz. In some examples, the one or more sets of electrodes may receive a direct and/or alternating electrical current at a particular voltage during manipulation of the droplet. For example, this particular voltage may be one or more of a variety of voltages from about 10 volts to about 1000 volts, for example about 10, 50, 100, 200, 300, 400 500, 600, 700, 800, 900, or 1000 volts.

In an example embodiment, in addition to controlling the transportation and/or manipulation (e.g., immobilizing) of the droplet on the surface of the cartridge, various antibodies, antigens, and/or other components may also be controlled, mixed, transported, and/or immobilized on the surface of the cartridge. Using this programmable protocol, antibodies, antigens, and/or other components may be adhered onto one or more surfaces of the plurality of particles (e.g., paramagnetic, bar-coded beads), which are referred to herein as the “assembled particles”. In a further aspect, one or more analyses may be performed on the assembled particles on the surface of the cartridge. In this regard, a user of the cartridge can perform complicated, often multi-step protocols, which are often spread over several machines and devices at various stages of the multi-step protocols, in a single cartridge and a single instrument/device. In one example embodiment, a multiplex multiple analyte targets in a single reaction may be performed on a droplet on the surface of the cartridge detailed above, instead of using multiple devices (e.g., shaker plates, pipettes, vials, plates with multiple wells, plate readers, cameras, etc.). In one example embodiment, a multiplex (i.e. multiple analyte targets in a single reaction) may be performed on a droplet in a portion of the surface of the cartridge comprising a single electrode. Other examples are possible.

For example, in some embodiments, the ratio of assembled particles to the volume of solution in the droplet might be adjusted to improve dispersion throughout the droplet for analysis and/or testing, while also providing an adequate number of particles for analysis and/or testing. For example, in example embodiments, this particular ratio may be one or more of a variety of number of assembled particles to volume of solution from about 20 assembled particles (e.g., paramagnetic, bar-coded beads) to about 300 assembled particles (e.g., paramagnetic, bar-coded beads) per microliter of solution, including 10, 20, 30, 40, 50, 60, 70, 80, 90, 100, 110, 120, 130, 140, 150, 200, 250, and 300 assembled particles (e.g., paramagnetic, bar-coded beads) per microliter of solution.

In some embodiments, it is beneficial to immobilize the droplet and/or components thereof (e.g., paramagnetic, bar-coded beads) for one or more steps in an assay. In some embodiments, as described above, immobilization of the droplets on the cartridge surface can be controlled by applying an electrical current (e.g., a direct electrical current) to one or more electrodes of the cartridge, including one or more electrodes circumscribing the optical read window. In some embodiments, immobilization of the droplet and/or components thereof (e.g., paramagnetic, bar-coded beads) on the cartridge surface can be also be controlled by the at least one magnet. In some example embodiments, the at least one magnet may be a permanent or semi-permanent magnet below or above one or more portions of the cartridge surface. In other embodiments, the at least one magnet may be an electric magnet configured to interact with the droplet and/or components thereof (e.g., paramagnetic, bar-coded beads) via a controller and/or other computing devices to create a programmable interaction along the fluidic path to promote assay protocols and subparts thereof.

In other examples, after one or more binding members have attached to the particles (e.g., paramagnetic, bar-coded beads), the solution surrounding the particles may be removed and the particles with attached binding members (collectively referred to herein as “assembled particles”) may be washed in preparation for testing. In an example embodiment, during this washing portion, one or more components may be used to facilitate the washing, including one or more components of a cartridge to manipulate (e.g., immobilize) the assembled particles in one or more portions of the cartridge. For example, because the assembled particles may have magnetic or paramagnetic properties, an electrical current and/or a magnet may be used to secure the assembled particles in a portion of the cartridge while a washing solution is dispersed into the cartridge to improve the results of the washing portion (e.g., by ensuring that the assembled particles remain intact and in a specific portion of the cartridge). Other improvements may be realized.

In this regard, by combining the technologies of the optical read window components of the cartridge, EWOD, magnetic, and particles (e.g., paramagnetic, bar-coded bead technologies), the concepts described herein provide disclosure for a compact, in clinic, instrument with multiplex capability that allow the mixing and manipulation of solutions, samples, and particles (including paramagnetic, bar-coded beads) on the surface of the cartridge. In an example embodiment, by leveraging these technologies, a platform is described that can have the same convenience as other tabletop devices (e.g., a SNAP® reader and device) but with the increased menu of capabilities for laboratory testing and assay protocols, including multi-part assays (e.g., multiplex lab tests), without the inconvenience and costs of the devices, instruments, and operators typically required for these tests and assays (e.g., liquid handling robots, plates, plate washers, and/or specialized plate readers). Further, in example embodiments, because multiple tests and assays may be completed on one or more small sample sizes (e.g., one or more droplets containing assembled paramagnetic, bar-coded beads), the present disclosure allows complex analysis (e.g., of multiple analytes) based on small volumes of samples, which is beneficial in instances where sample volume is an issue.

In one example, a user may add a sample (e.g., a fecal sample, urine sample, blood sample, etc.) into a reservoir of the cartridge, insert a cartridge into a tabletop instrument/device, and allow the instrument/device to add and/or control other components (e.g., paramagnetic, bar-coded beads, solution, antibodies, etc.) on the cartridge, and analyze one or more components to provide one or more results to clinician, physician, and/or patient based on the same, all using the same sample, cartridge and instrument/device. Importantly, once the user inserts the cartridge into the tabletop instrument device, some (or all) of the fluidics, manipulation of the components in the cartridge (including the paramagnetic, bar-coded beads), illumination of the particles located on the optical read window (e.g., via backlighting and/or sidelighting), and the eventual imaging and/or reading of these components are all automated, controlled, and finely-tuned by program instructions executing on a computing device, all of which may be accomplish without user interaction or control.

By doing so, several benefits are realized, including users (e.g., clinicians) having the same high throughput/multiplexing capability of the traditional technologies without the required overhead of user controlling or coordinating every step of the process or the multitude of separate devices and components required to accomplish the tests and/or assays. Time to result would also be improved, instead of sending samples to a lab and waiting for a prolonged period of time for results (sometimes several days), users could have results in a matter of minutes, and all while using a single sample on a single cartridge in connection with a single device. This improved time to result also improves the ability for a treating physician and/or patient to receive results in a more timely manner (e.g., results could be shared with the patient during the visit) and make more timely decisions based thereon.

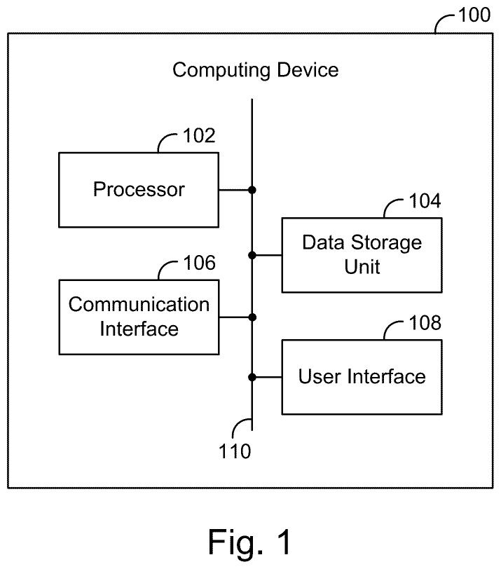

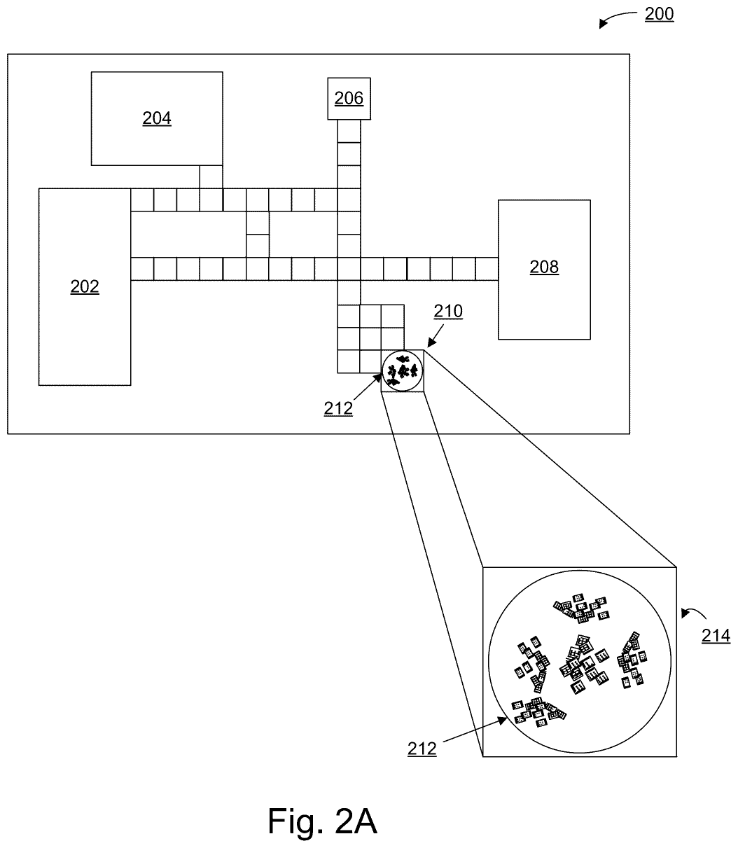

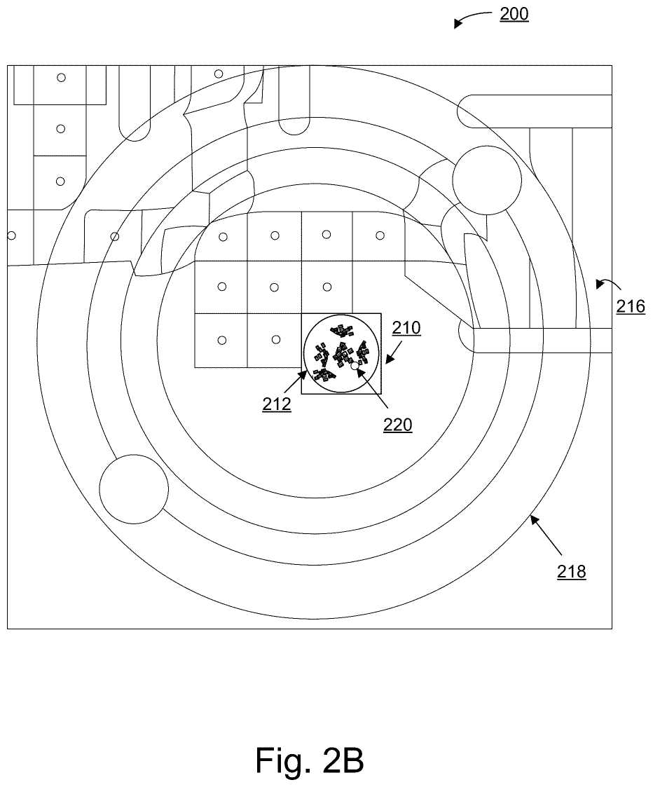

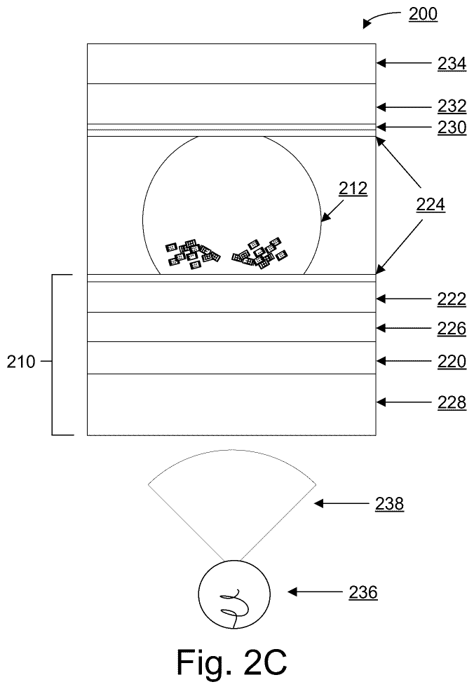

Referring now to the figures, FIG. 1 is a simplified block diagram of an example computing device 100 of a system (e.g., those illustrated in FIGS. 2A-5, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (DSP)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Now referring to FIGS. 2A-2C, an example cartridge 200 is disclosed, which includes a sample reservoir 202, a solution reservoir 204, an assay component reservoir 206, a waste reservoir 208, and a testing location 210, that reside on a dielectric cartridge surface, according to the illustrated example embodiment. In this example embodiment, one or more sets of a plurality of electrodes are disposed along various portions of dielectric cartridge surface, including in the illustrated plurality of paths that connect testing location 210 to sample reservoir 202, a solution reservoir 204, an assay component reservoir 206, a waste reservoir 208, and all of those components to one another. As illustrated in FIG. 2A (and FIGS. 2B-2C), the plurality of paths (and the underlying one or more sets of electrodes) are shown as the series of illustrated small squares that connect testing location 210 to sample reservoir 202, a solution reservoir 204, an assay component reservoir 206, a waste reservoir 208, and all of those components to one another.

As noted above, these sets of electrodes facilitate transportation and manipulation of a fluid droplet containing a plurality of particles (e.g., a plurality of paramagnetic, bar-coded beads) along dielectric cartridge surface of cartridge 200. For clarity, as illustrated in FIG. 2A (and FIGS. 2B-2C), the term “dielectric cartridge surface” as used in FIG. 2A (and FIGS. 2B-2C) includes the cartridge surfaces below the illustrated sample reservoir 202, a solution reservoir 204, an assay component reservoir 206, a waste reservoir 208, and a testing location 210, as well as the illustrated paths that connects all of these components in FIGS. 2A-2C. As further illustrated in FIG. 2A (and FIGS. 2B-2C), a droplet 212 containing a plurality of particles is located on testing location 210, an exploded view 214 of which is also illustrated in FIG. 2A.

Now referring to FIG. 2B, a magnified view 216 of cartridge 200 is illustrated using a magnifying lens 218. As shown in FIG. 2B, a plurality of assembled particles are illustrated in droplet 212, which resides on the dielectric cartridge surface at testing location 210. As shown in FIG. 2B, the dielectric surface under droplet 212 is a square, with a single electrode 220, among a plurality of electrodes at other portions of the cartridge 200 (illustrated in FIG. 2B as small circles inside of the individual illustrated small squares that connect testing location 210 to the other illustrated components of cartridge 200, as well as connect those other components to one another). As also shown in FIG. 2B, the assembled particles are illustrated in droplet 212 are prone to a substantial amount of “clumping”, which causes, among other issues, inaccurate imaging of the droplet 212 and the assembled particles thereof.

Now referring to FIG. 2C, a cross-sectional view of cartridge 200 is illustrated. As shown in FIG. 2C, a plurality of assembled particles are presented in droplet 212, which resides on dielectric surface 222 via hydrophobic coating 224. As also shown in FIG. 2C, cartridge 200 further comprises an adhesive layer 226, electrode 220, and substrate 228. As illustrated in FIG. 2C, collectively, dielectric surface 222, the bottom portion of hydrophobic coating 224, adhesive layer 226, electrode 220, and substrate 228 make up the testing location 210 on which the droplet 212 resides. As also shown in FIG. 2C, cartridge 200 further comprises conductive coating 230, top plate 232, and cartridge cover 234. In a further aspect, one or more components of cartridge 200 illustrated in FIG. 2C may not be to scale and/or the precise proportions of the actual embodiment of cartridge 200, and are merely illustrated as a simplistic representation of the materials and components of an example embodiment of cartridge 200. Furthermore, because one or more of the materials of the testing location 210 of cartridge 200 may be opaque or substantially opaque, then light source 236 may not pass light 238 through the materials of testing location 210, which may result in darker, less focused imaging results of droplet 212.

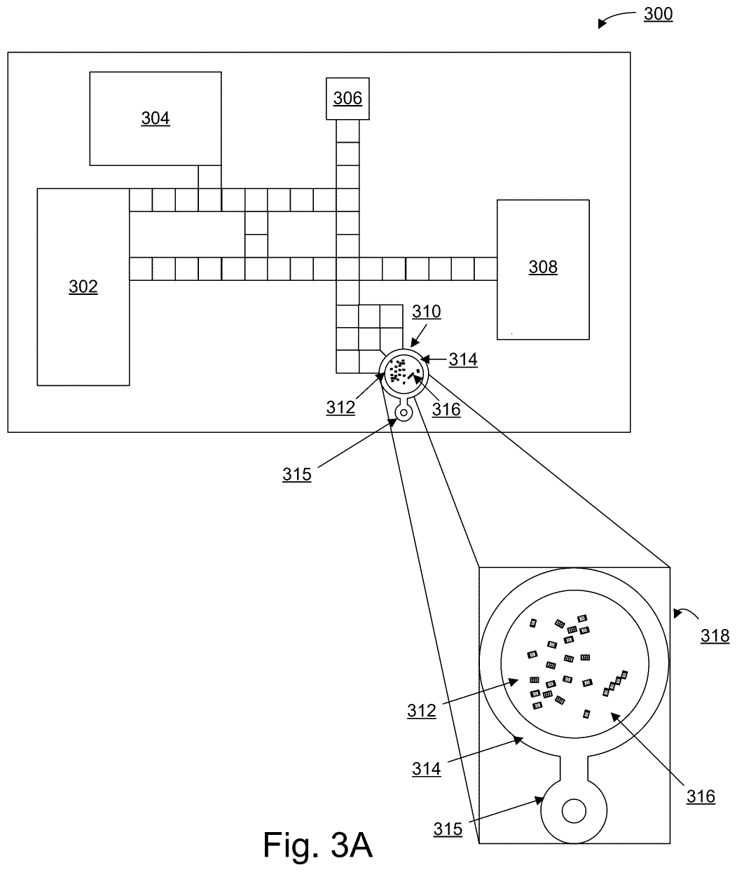

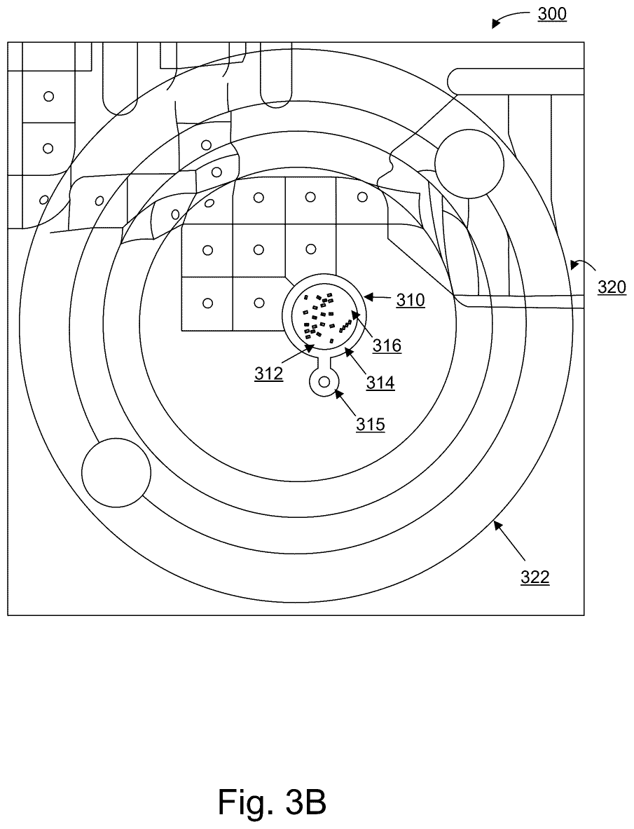

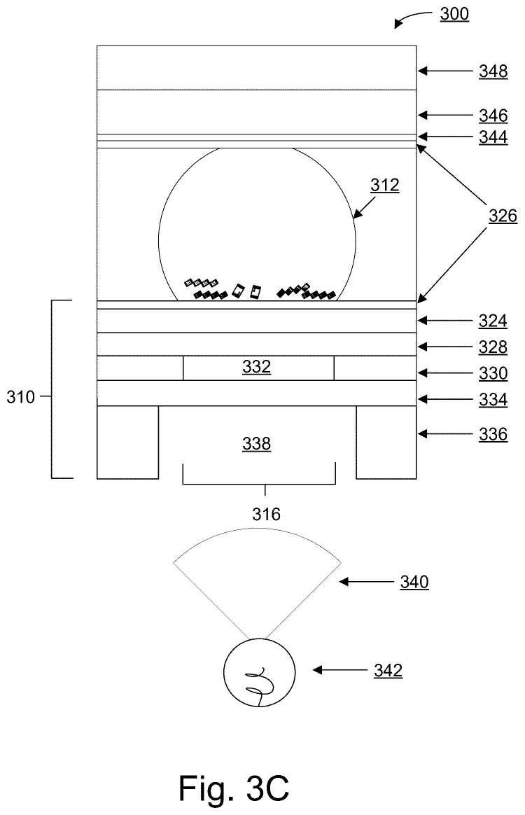

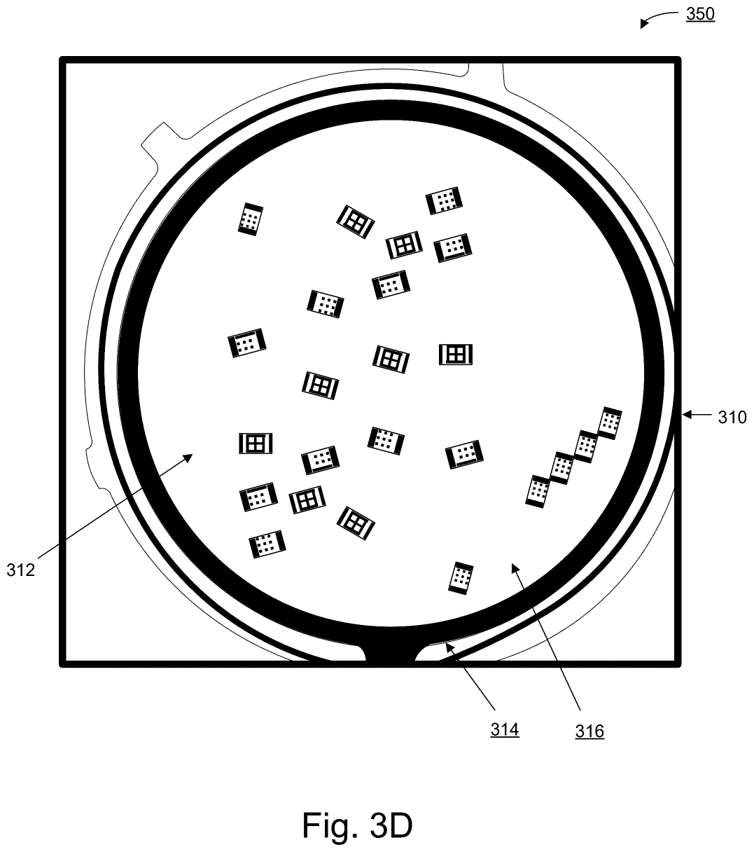

Now referring to FIGS. 3A-3D, an example cartridge 300 is disclosed, which includes a sample reservoir 302, a solution reservoir 304, an assay component reservoir 306, a waste reservoir 308, and a testing location 310, that reside on a dielectric cartridge surface, according to the illustrated example embodiment. In this example embodiment, one or more sets of a plurality of electrodes are disposed along various portions of dielectric cartridge surface, including in the illustrated plurality of paths that connect testing location 310 to sample reservoir 302, a solution reservoir 304, an assay component reservoir 306, a waste reservoir 308, and all of those components to one another. As illustrated in FIG. 3A (and FIGS. 3B-3D), the plurality of paths (and the underlying one or more sets of electrodes) are shown as the series of illustrated small squares that connect testing location 310 to sample reservoir 302, a solution reservoir 304, an assay component reservoir 306, a waste reservoir 308, and all of those components to one another.

As noted above, these sets of electrodes facilitate transportation and manipulation of a fluid droplet containing a plurality of particles (e.g., a plurality of paramagnetic, bar-coded beads) along dielectric cartridge surface of cartridge 300. For clarity, as illustrated in FIG. 3A (and FIGS. 3B-3D), the term “dielectric cartridge surface” as used in FIG. 3A (and FIGS. 3B-3D) includes the cartridge surfaces below and around the illustrated sample reservoir 302, a solution reservoir 304, an assay component reservoir 306, a waste reservoir 308, and a testing location 310, as well as the illustrated paths that connects all of these components in FIGS. 3A-3D. As further illustrated in FIG. 3A (and FIGS. 3B-3D), a droplet 312 containing a plurality of particles is located inside a substantially circular electrode 314 (that also contains a linear electrode portion 315) and above optical read window 316 of testing location 310, an exploded view 318 of which is also illustrated in FIG. 3A.

Further, although the optical read window 316, substantially circular electrode 314, and portions of linear electrode portion 315 are illustrated as a substantially circular shape in FIGS. 3A-3D, it should be noted that one or more of these components (or others) may be one or more different shapes, including: rectangular, substantially rectangular, square, substantially square, rounded, substantially rounded, circular, substantially circular, triangular, substantially triangular, pentagonal, substantially pentagonal, hexagonal, substantially hexagonal, heptagonal, substantially heptagonal, octagonal, substantially octagonal, decagonal, and substantially decagonal, among others. Other examples are possible.

In examples, the cartridge 300 and/or any components thereof may interact with a computing device, such as computing device 100. As described above, a computing device 100 can be implemented as a controller, and a user of the controller can use the controller to program and/or control cartridge 300 and/or any components thereof. The cartridge 300 and/or any components thereof may communicably coupled with a controller, such as computing device 100, and may communicate with the controller by way of a wired connection, a wireless connection, or a combination thereof. Further, as described above, a controller may be configured to control various aspects of the illustrated cartridge 300 and testing protocols (e.g., assays) utilizing cartridge 300 and/or any components thereof. Although various cartridge components and arrangements of these components a are provided for explanatory purposes, and different shapes, amounts, and/or types of beads, particles, and/or components may be used.

In examples, the controller can execute a program that cause one or more components of the cartridge 300 to perform a series of events by way of a non-transitory computer-readable medium having stored program instructions. These program instructions include, for example, applying voltage and/or current to one or more electrodes near (e.g., below) the dielectric materials of dielectric cartridge surface to manipulate one or more droplets (or components thereof) along the dielectric cartridge surface, including along the illustrated plurality of paths that connect sample reservoir 302, a solution reservoir 304, an assay component reservoir 306, a waste reservoir 308, and a testing location 310, as illustrated in FIGS. 3A-3D. In some examples, the one or more electrodes may be used to transport one or more droplets between the illustrated components of FIGS. 3A-3D and/or manipulate (e.g., immobilize) the one or more droplets and/or components thereof at one more locations of the dielectric cartridge surface.

For example, certain voltages/currents amplitudes and patterns, as well as electrode placement around the surface of the dielectric cartridge surface may more effectively agitate the droplet to produce more accurate and consistent mixing (e.g., of the plurality of particles throughout the droplet) and associated assay results than other methods. For example, one or more sets of electrodes may receive a particular alternating electrical current at a particular frequency (e.g., 30 hertz) and/or voltage (e.g., 300 volts) that causes the droplet to be transported along the surface of the cartridge such that the droplet is moving at a particular transport speed such that the droplet does not reside in one location on the cartridge surface for more than a threshold amount of hold time (e.g., 200 milliseconds) during transportation. In examples, the controller may transport the droplet around the surface of the cartridge along one or more predefined paths, potentially a number of times, according to one or more of the parameters detailed above (e.g., at one or more of a particular voltage, frequency, transport speed, hold time, etc.). Further, the controller may transport the droplet around the surface of the cartridge via program instructions that include moving various fluids around the surface of the cartridge and perform various aspects of an assay, all on the surface of the cartridge and all in an automated (or largely automated) procedure.

In example embodiments, the one or more sets of electrodes may transport a droplet containing a plurality of particles on the dielectric cartridge surface along the illustrated plurality of paths that connect sample reservoir 302, a solution reservoir 304, an assay component reservoir 306, a waste reservoir 308, and a testing location 310. In examples, the plurality of particles (e.g., paramagnetic, bar-coded beads) may be introduced into a droplet, either in a liquid suspension or dried onto a surface of the cartridge 300 and rehydrated. In one example, the plurality of particles may be suspended in buffer solution containing sucrose, removed from the suspension, and dried before being stored in assay component reservoir 306. In examples, the plurality of particles may be rehydrated with one or more solutions containing one or more components (e.g., reagents, sample, or both, among other possibilities) before being used in one or more aspects of an assay. In example embodiments, once the plurality of particles are rehydrated and/or introduced into a fluidic droplet, the droplet containing the plurality of particles may be transported from assay component reservoir 306 to sample reservoir 302 to be mixed with a sample residing in sample reservoir (e.g., a fecal sample, urine sample, blood sample, etc.).

In a further aspect, in example embodiments, the one or more sets of electrodes may transport a droplet of assay components (e.g., containing antibodies, antigens, labels, and/or other binding members) on the dielectric cartridge surface. In examples, these assay components may be introduced into a droplet, either in a liquid suspension or dried onto a surface of the cartridge 300 and rehydrated. Either way, once the plurality of particles are introduced into the droplet, a droplet containing plurality of particles may be transported from assay component reservoir 306 to sample reservoir 202 to be mixed with a sample residing in sample reservoir. Furthermore, although assay component reservoir 306 is illustrated as a single reservoir in FIG. 3A, it should be apparent to a person of ordinary skill in the art that assay component reservoir 306 may comprise multiple, separate reservoirs, each of which may contain a particular assay components or combination thereof (e.g., a particular antibodies, antigens, labels, and/or other binding members). Additionally or alternatively, although specifically illustrated in FIG. 3A, there may be multiple assay component reservoirs in cartridge 300, each with their own associated assay component and/or path on the dielectric cartridge surface.

In example embodiments, a variety of techniques can be used facilitate the dispersion of the plurality of particles, other assay components and/or the sample within the droplet. In a further aspect, these techniques may also be used to further facilitate mixing the plurality of particles, other assay components and/or the sample (e.g., in the sample reservoir 302) at various mixing speeds, patterns, etc., all of which may be controlled by the controller executing program instructions controlling the components of the cartridge 300.

In example embodiments, once the droplet containing the plurality of particles (e.g., paramagnetic, bar-coded beads), the sample, and/or other assay components is sufficiently mixed, all of these components may incubate in the sample reservoir 302 (e.g., to allow attachment of one or more assay components and/or components of the sample to attach to the paramagnetic, bar-coded beads). In example embodiments, once the incubation is complete, the plurality of particles and the attached sample and/or assay components (collectively, the “assembled particles”) may be further manipulated in the sample reservoir 302 (e.g., immobilized using an electrical current and/or a magnet). Once assembled, the fluids surrounding the plurality of particles and the attached sample and/or assay components may be removed and transported to waste reservoir 308 along dielectric cartridge surface.

In example embodiments, excess debris and/or other components may also be washed from the assembled particles, and the excess solution (and any other excess fluids) may be transported to waste reservoir 308 along dielectric cartridge surface (e.g., using one or more sets of electrodes). Once the assembled particles are completed and ready for analysis, in example embodiments, the assembled particles may be transported to a portion of the cartridge for analysis, including testing location 310. Prior to analyzing the assembled particles, one of several steps may be undertaken to improve the accuracy and precision of the analysis.

In example embodiments, the assembled particles may be disposed in a liquid (e.g., a solution from solution reservoir 304) and transported via fluidic transportation across the dielectric cartridge surface, via one or more sets of electrodes (i.e., moving the assembled particles along one or more paths of the dielectric cartridge surface), to the testing location 310.

In examples, once the droplet and the plurality of particles reach the testing location 310, one or more additional mechanical actions may be taken on the droplet and/or the components therein, including the assembled particles. For example, the droplets and/or or components thereof may be manipulated and/or otherwise controlled by one or more electrodes (e.g. ring electrode 314 and/or linear electrode portion 315) that receive an electrical current that manipulates (e.g., immobilizes) the droplet. In some examples, substantially circular electrode 314 (and/or linear electrode portion 315) may receive a direct electrical current (“DC”) that immobilizes the droplet and/or the components thereof at testing location 310 during testing and/or analysis. In some examples, particularly if the droplet and/or the components thereof have magnetic or paramagnetic properties, if one or more of the electrodes in or around testing location 310 (e.g., ring electrode 214) receive a direct electrical current, then the droplet and/or the components may align and/or otherwise be oriented in one or more particular orientations (e.g., due to the DC creating a magnetic field in one or more particular directions). Other examples are possible.

In examples, testing location 310 provides a predetermined location for a reader to conduct the analysis and/or testing (e.g., assay testing) on the assembled particles. In example embodiments, the reader may detect, shortly after the assembled particles arrive at the testing location 310, an assay read signal corresponding to at least one of the assembled particles at the testing location 310. In some example embodiments, this detection and/or analysis may occur within a predetermined time period after the assembled particles arrive at the testing location 310 and any manipulation (e.g., immobilization via substantially circular electrode 314 and/or linear electrode portion 315) has been undertaken. For example, in an example embodiment, once the droplet arrives at the testing location 310 after any one or more of the transportation protocols described above, a direct electrical current may be applied to the substantially circular electrode 314 and/or linear electrode portion 315 for a predetermined amount of time prior to testing and/or analysis. For example, the droplets containing the assembled particles may be immobilized and/or otherwise manipulated by one or more electrodes (e.g., via direct electrical current at 300 volts) for a threshold amount of time (e.g., 5000 milliseconds) prior to analysis. Other examples are possible.

In an example embodiment, during analysis, one or more cameras and/or an optics system reader may be employed to capture images of the assembled particles and/or decode properties of these particles (e.g., decoding the individual bar codes of the paramagnetic, bar-coded beads). In other examples, one or more sets of electrodes and/or one or more magnets may be used to manipulate the paramagnetic, bar-coded beads while reading other parameters of the droplet containing the assembled particles and/or the assembled particles themselves. In some examples, testing location 310 may include an optical read window 316 that allows light to transmit through the material on which the droplet, plurality of particles, and/or other testing components reside during testing and/or other analytical protocols. In some examples, light may transmit through the optical read window pursuant to the optical read window containing one or more optically transparent (or substantially optically transparent) material, including one or more of: (i) polyethylene terephthalate (PET); (ii) polyethylene (PE); (ii) acrylic; (iv) glass; (v) polyvinyl chloride (PVC); (vi) polycarbonate (PC); (vii) silicone; and (viii) synthetic rubber. Other examples are possible.

In some examples, the optical read window 316 may have one or more physical and/or chemical characteristics that may be improved by introducing one or more additional materials, then, in some embodiments, these secondary materials may be added to the optical read window components and/or components that surround the optical read window. For example, in some embodiments, the optical read window materials may benefit from adding a stiffening materials around the optically transparent material, including one or more of: (i) glass-reinforced epoxy resin laminate; (ii) polybutylene terephthalate (PBT); (iii) polyethylene terephthalate (PET); (iv) polyethylene (PE); (v) acrylic; (vi) glass; (vii) plastic; (viii) polyvinyl chloride (PVC); (ix) polycarbonate (PC); (x) metal; (xi) metal alloy; (xii) paper materials; (xiii) cardboard; (xiv) cellulose; and (xv) rubber materials. In some examples, one or more of these stiffening materials may circumscribe the optical read window to provide structural support for the optical read window, while also not interfering with the optically transparent materials of the optical read window. In a further aspect, as the materials of the optical read window 316 may be transparent or substantially transparent, during analysis, one or more cameras and/or an optics system reader may be employed to capture images of the assembled particles and/or decode properties of these particles while applying a light source and capturing one or more characteristics of the assembled particles that are more observable during illumination. As illustrated in FIG. 3A, exploded view 318 of testing location 310 provide an example view of paramagnetic, bar-coded beads, and it should be appreciated that this analysis (e.g., reading) could occur at other portions of the cartridge 300, including along other location of the paths and/or other dielectric cartridge surface portions of the cartridge 300. Other examples are possible.

For example, to help measure the dispersion and consistency of the assembled particles in the droplet solution, an image of the droplet of solution may be generated. In examples, this image may contain a plurality of images of the droplet of solution and based on one or more attributes of this generated image, one or more parameters may be determined for the droplet and/or the components thereof. For example, the generated image may also be used to identify one or more characteristics of the individual particles in the droplet. For example, if the particles include paramagnetic beads that include one or more unique bar codes, the generated image may be used to identify one or more unique bar codes in the image corresponding to the individual particles in the transferred aliquot of solution. In example embodiments, the one or more unique bar codes identified in the generated image can also be used to determine an assay result. In example embodiments, the one or more unique bar codes identified in the generated image can also be compared to an assay result generated from another source (e.g., a reader) and/or used to determine the accuracy of the results from another source (e.g., by comparing the assay results from the reader to those determined from the generated image).

Now referring to FIG. 3B, a magnified view 320 of cartridge 300 is illustrated using a magnifying lens 322. As shown in FIG. 3B, a plurality of assembled particles are illustrated in droplet 312, which resides on the dielectric cartridge surface at testing location 310. As shown in FIG. 3B, the dielectric surface under droplet 312 is a circular optical read window 316, circumscribed by a substantially circular electrode 314, among one or more sets electrodes at other portions of the cartridge 300 (the other electrodes are illustrated in FIG. 3B as small circles inside of the individual illustrated small squares that connect testing location 310 to the other illustrated components of cartridge 300, as well as connect those other components to one another). As also shown in FIG. 3B, the assembled particles are illustrated in droplet 312 located on the optical read window that has a diameter and shape that, in one or more particular ratios with the droplet volume, minimizes the area of the droplet that is occluded by the substantially circular electrode 314 during imaging. The features and others described herein improve, among other issues, imaging of the droplet 312 and the assembled particles thereof, particularly when paired with illumination that may occur from a light source illuminating the optical read window 316 (e.g., from a backlighting light source under the surface of optical read window 316). Other examples are possible.

Now referring to FIG. 3C, a cross-sectional view of cartridge 300 is illustrated. As shown in FIG. 3C, a plurality of assembled particles are presented in droplet 312, which resides on dielectric surface 324 via hydrophobic coating 326. As also shown in FIG. 3C, cartridge 300 further comprises an adhesive layer 328, electrode 330 (e.g., substantially circular electrode 314 with a first portion 332 removed from substantially circular electrode 314), substrate 334, and stiffening material 336 with a second portion 338 removed from stiffening material 336). As illustrated in FIG. 3C, collectively, dielectric surface 324, the bottom portion of hydrophobic coating 326, adhesive layer 328, electrode 330, substrate 334, and stiffening material make up the testing location 310 on which the droplet 312 resides. As also illustrated in FIG. 3C, in example embodiments, because the dielectric surface 324, the bottom portion of hydrophobic coating 326, adhesive layer 328, and the substrate 334 are made of one or more optically transparent materials (e.g., PET), and the optically opaque components (e.g., electrode 330 and/or stiffening material 336) have one or more portions removed that disposed beneath droplet 312 (e.g., first portion 332 and/or second portion 338), the combination of the components creates an optical read window 316 that allows light 340 (e.g., from light source 342), which may result in a brighter, higher contrast imaging results of droplet 312 and the components thereof (e.g., paramagnetic, bar-coded beads). In example embodiments, this combination of components provides a less reflective surface and improvements to existing systems and devices, as they provide more consistent, higher contrast, imaging results of droplet 312 and the components thereof (e.g., paramagnetic, bar-coded beads).

As also shown in FIG. 3C, cartridge 300 further comprises conductive coating 344, top plate 346, and cartridge cover 348. In a further aspect, one or more components of cartridge 300 illustrated in FIG. 3C may not be to scale and/or the precise proportions of the actual embodiment of cartridge 300, and are merely illustrated as a simplistic representation of the materials and components of an example embodiment of cartridge 300. Other examples are possible.

Turning to FIG. 3D, a sample image 350 of testing location 310 of cartridge 300 that resides under droplet 312, and includes optical read window 316 circumscribed by a substantially circular electrode 314 that also contains a linear electrode portion, all of which is illustrated according to an example embodiment.

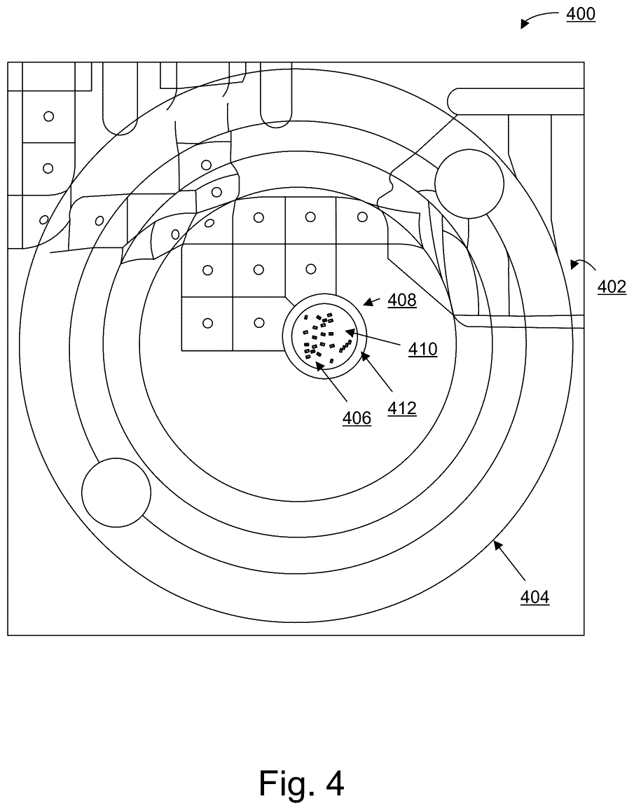

Now referring to FIG. 4, a magnified view 402 of an alternative embodiment cartridge 400 is illustrated using a magnifying lens 404. As shown in FIG. 4, an alternative embodiment of cartridge 300 (as illustrated in FIGS. 3A-3D) is illustrated that comprises a plurality of assembled particles in droplet 406, which resides on the dielectric cartridge surface at testing location 408.

As shown in FIG. 4, the dielectric surface under droplet 406 is a circular optical read window 410, circumscribed by a ring electrode 412, among one or more sets electrodes at other portions of the cartridge 400 (the other electrodes are illustrated in FIG. 4 as small circles inside of the individual illustrated small squares that connect testing location 408 to the other illustrated components of cartridge 400, as well as connect those other components to one another). As also shown in FIG. 4, the assembled particles are illustrated in droplet 406 are located on the optical read window that has a diameter and shape that, in one or more particular ratios with the droplet volume, minimizes the area of the droplet that is occluded by the ring electrode 412 during imaging. The features and others described herein improve, among other issues, imaging of the droplet 406 and the assembled particles thereof, particularly when paired with illumination that may occur from a light source illuminating the optical read window 410 (e.g., from a backlighting light source under the surface of optical read window 410).

Further, although the optical read window 410 and ring electrode 412 are illustrated as a substantially circular shape in FIG. 4, it should be noted that one or more of these components (or others) may be one or more different shapes, including: rectangular, substantially rectangular, square, substantially square, rounded, substantially rounded, circular, substantially circular, triangular, substantially triangular, pentagonal, substantially pentagonal, hexagonal, substantially hexagonal, heptagonal, substantially heptagonal, octagonal, substantially octagonal, decagonal, and substantially decagonal, among others. Other examples are possible.

As described herein, the particles illustrated in FIGS. 2A-4 may be utilized during one or more assay procedures, including, for example, to identify a particular type and/or subset of components within a sample. In some example embodiments, each of the assembled particles includes a unique bar code. In another example, each of the assembled particles include two or more unique bar codes. In yet another example, a subset of the assembled particles may include one unique bar code and the remaining assembled particles may include two or more unique bar codes. In practice, each of these bar codes may correspond to particular information about the paramagnetic bead, the droplet of solution, and/or one or more additional parameters (including those used in an assay). For example, these unique bar codes may be utilized during one or more assay procedures to identify a particular type and/or subset of paramagnetic beads within the solution.

It should also be noted that although the particles illustrated in FIGS. 2A-4 involve paramagnetic beads, different shapes, amounts, and/or types of particles may be used.

It should also be noted that one or more concepts illustrated in FIGS. 2A-4 may be accomplished using a computing device, such as computing device 100. As described above, a computing device 100 can be implemented as a controller, and a user of the controller can use the controller to control the capturing of one or more images of the droplet of solution, as well as process the plurality of images to generate and/or annotate one or more images of the plurality of images.

In examples, the controller can execute a program that causes the controller and/or components operating therewith (e.g., a camera) to perform a series of actions by way of a non-transitory computer-readable medium having stored program instructions.

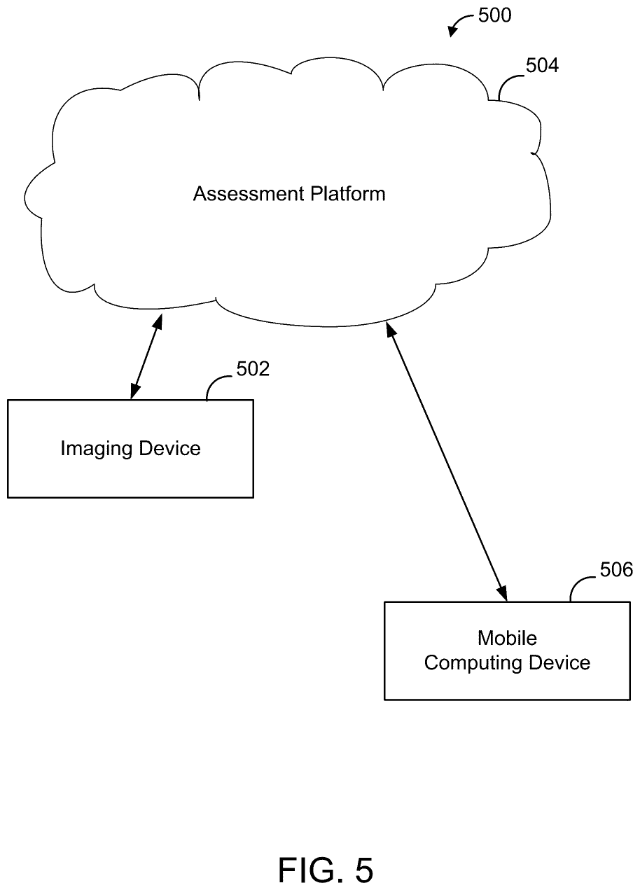

Now referring to FIG. 5, a computing system 500 configured for use with an imaging device 502 and a mobile computing device 506, according to an example embodiment. Example devices (e.g., 200, 300, and 400) are compatible with an imaging device 502 that can read an optical signal present on a cartridge and/or a test strip. Signals may include a color or intensity of light associated with the test strip or may detect an image present on the strip that is associated with a bead (e.g., barcoded, shape, size, etc.) present on the strip. An imaging device 502 includes a computing device, such as computing device 100. It should also be readily understood that computing device 100 and the imaging device 502, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 500 can include various components, such as the computing device 100, imaging device 502, a cloud-based assessment platform.

The imaging device 502 and/or components thereof can perform various acts and/or functions (many of which are described above). Examples of these and related features will now be described in further detail.

The imaging device 502 may collect data from a number of sources. In one example, the imaging device 502 may collect data from a database of images related to testing of samples, including one or more images of the droplets, plurality of particles, cartridges, and/or components thereof. The images may be uploaded to an assessment platform 504 and characteristics of the images may be output to a mobile computing device 506.

In an example, assessment platform 504 may collect data from one or more sensors communicably coupled to the imaging device 502, such as an imaging sensor, concerning a particular sample. In such examples, the assessment platform 504 may identify a characteristic of the droplet or a testing result and transmit instructions to the mobile computing device 506 to cause a graphical user interface to display a graphical indication of the identified characteristic and/or testing result. In some examples, the assessment platform 504 may determine a testing result by utilizing one or more of: (i) an artificial neural network, (ii) a support vector machine, (iii) a regression tree, or (iv) an ensemble of regression trees.

In another example, the imaging device 502 may collect data from one or more sensors communicably coupled to the imaging device, such as an imaging sensor, concerning a particular droplets, one or more particles, and/or cartridge. In some examples, the assessment platform 504 may determine a characteristic of the droplet and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 502 may train a machine learning model using data associated images of droplets, one or more particles, and/or cartridges that share a characteristic with captured images of droplets, one or more particles, and/or cartridges. The machine learning model may be trained using training data that shares a characteristic and/or testing result with droplets, one or more particles, and/or cartridges to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 502 may be adjusted based on training such that if the outcome of a determined testing result matches the characteristic and/or testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 502 has determined a characteristic of a droplet and/or one or more particles in one or more images, the imaging device may transmit instructions that cause a computing device (e.g., the computing device 100) to display one or more graphical indications of the identified characteristic and/or the enhanced image.

In some example embodiments, the droplet and/or plurality of particles can be used for a variety of tests. For instance, these tests may include imaging of one or more of the following: (i) blood; (ii) urine; (iii) saliva; (iv) fecal matter; (v) secretion; (vi) excretion; (vii) FNA; (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities. Test may additionally include one or more of the following: blood coagulation test, polymerase chain reaction (PCR) test, and/or immunoassay, among other possibilities. For example, in some example embodiments, these tests may include one or more of the following blood chemistry tests: SDMA, Total T4 (TT4), Bile Acids, C-reactive Protein (CRP), Progesterone, Fructosamine, and/or Phenobarbital (PHBR), among other possibilities. For example, in some example embodiments, these tests may include one or more of the following blood chemistry profile tests that measure one or more of the following: ALB, ALB/GLOB, ALKP, ALT, AMYL, AST, BUN, BUN/CREA, Ca, CHOL, CK, CI, CREA, CRP, FRU, GGT, GLOB, GLU, K, LAC, LDH, LIPA, Mg, Na, NH₃, PHOS, TBIL, TP, TRIG and/or URIC, among other possibilities. Other examples are possible.

### Example Methods and Aspects

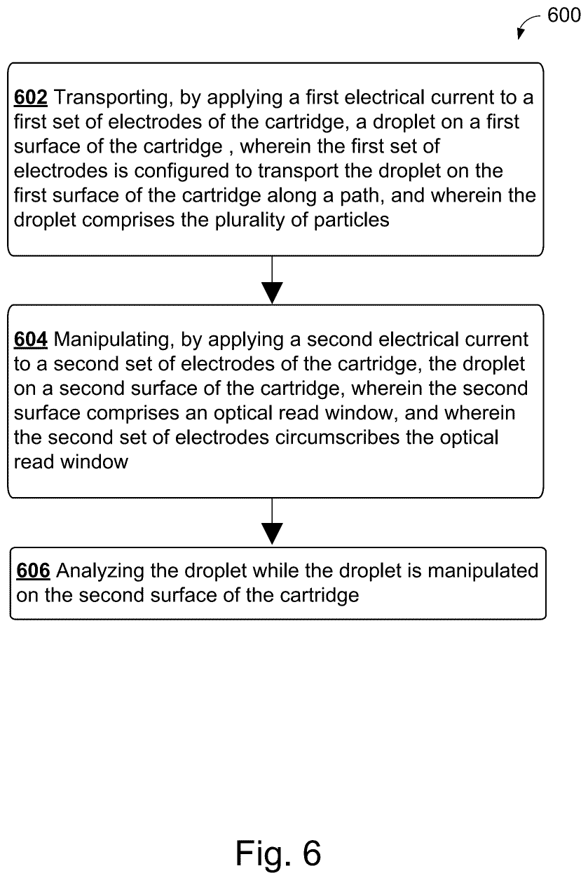

Now referring to FIG. 6, an example method of analyzing a plurality of particles of a droplet on an optical read window of a cartridge is disclosed.

Method 600 shown in FIG. 6 presents an example of a method that could be used with the components shown in FIGS. 1-4B, for example. Further, devices or systems may be used or configured to perform logical functions presented in FIG. 5. In other examples, components of the devices and/or systems may be arranged to be adapted to, capable of, or suited for performing the functions, such as when operated in a specific manner. Method 600 may include one or more operations, functions, or actions as illustrated by one or more of blocks 602-606. Although the blocks are illustrated in a sequential order, these blocks may also be performed in parallel, and/or in a different order than those described herein.

Also, the various blocks may be combined into fewer blocks, divided into additional blocks, and/or removed based upon the desired implementation.

At block 602, method 600 involves transporting, by applying a first electrical current to a first set of electrodes of the cartridge, the droplet on the first surface of the cartridge a droplet on a first surface of the cartridge, wherein the first set of electrodes is configured to transport the droplet on the first surface of the cartridge along a path, and wherein the droplet comprises the plurality of particles.

In some example embodiments, the plurality of particles comprises at least one paramagnetic, bar-coded bead. In some embodiments, the at least one paramagnetic, bar-coded bead of the droplet comprises one or more unique bar codes. In other examples, the at least one paramagnetic, bar-coded bead of the droplet comprises at least one non-spherical, paramagnetic, bar-coded bead. In other examples, the at least one paramagnetic, bar-coded bead of the droplet comprises at least one spherical, paramagnetic, bar-coded bead. In some examples, the at least one paramagnetic, bar-coded bead of the droplet is between approximately 0.1 and 100 microns in size. In some examples, the droplet further comprises a solution for washing the at least one paramagnetic, bar-coded bead of the droplet. In some examples, the droplet further comprises a read buffer solution.

In some examples, the first surface of the cartridge comprises a dielectric material. In some examples, the first electrical current comprises a direct electrical current.

At block 604, method 600 involves manipulating, by applying a second electrical current to a second set of electrodes of the cartridge, the droplet on a second surface of the cartridge, wherein the second surface comprises the optical read window, and wherein the second set of electrodes circumscribes the optical read window.

In some examples, the second surface of the cartridge comprises a dielectric material. In some examples, the first electrical current comprises a direct electrical current. In some examples, the first electrical current comprises an alternating electrical current.

In some examples, the optical read window of the cartridge comprises an optically transparent material. In some examples, the optically transparent material comprises one or more of: (i) polyethylene terephthalate (PET); (ii) polyethylene (PE); (ii) acrylic; (iv) glass; (v) polyvinyl chloride (PVC); (vi) polycarbonate (PC); (vii) silicone; and (viii) synthetic rubber. In some examples, the optical read window of the cartridge further comprises a stiffening material. In some examples, the stiffening material comprises one or more of: (i) glass-reinforced epoxy resin laminate; (ii) polybutylene terephthalate (PBT); (iii) polyethylene terephthalate (PET); (iv) polyethylene (PE); (v) acrylic; (vi) glass; (vii) plastic; (viii) polyvinyl chloride (PVC); (ix) polycarbonate (PC); (x) metal; (xi) metal alloy; (xii) paper materials; (xiii) cardboard; (xiv) cellulose; and (xv) rubber materials. In some examples, the stiffening material circumscribes the optical read window.

In some examples, the optical read window of the cartridge comprises a rounded optical read window. In some examples, the optical read window of the cartridge comprises a semi-rounded optical read window. In some examples, the second set of electrodes comprises a single electrode. In some examples, the second set of electrodes comprises two or more electrodes.

At block 606, method 600 involves analyzing the droplet while the droplet is manipulated on the second surface of the cartridge.

In some examples, analyzing the droplet comprises performing one or more assay procedures on the droplet, and wherein, during the one or more assay procedures, determining a parameter of the droplet. In some examples, determining a parameter of the droplet comprises identifying a particular feature of the plurality of particles of the droplet, and wherein the plurality of particles comprises at least one paramagnetic, bar-coded bead. In other examples, determining a parameter of the droplet comprises identifying a particular feature of the at least one paramagnetic, bar-coded bead of the droplet.

In some examples, analyzing the droplet further comprises, while generating an image of the droplet on the second surface of the cartridge, applying at least one of a fluorescent and brightfield light to the droplet. In some examples, applying at least one of a fluorescent and brightfield light to the droplet comprises backlighting the droplet by applying at least one of a fluorescent and brightfield light to an opposing surface of the optical read window, wherein the opposing surface of the optical read window opposes the second surface of the cartridge. In some examples, applying at least one of a fluorescent and brightfield light to the droplet comprises sidelighting the droplet by applying at least one of a fluorescent and brightfield light to the second surface of the cartridge.

In some examples, analyzing the droplet comprises generating an image of the droplet on the surface of the cartridge, wherein the image comprises an image of the plurality of particles of the droplet, and wherein the plurality of particles comprises at least one paramagnetic, bar-coded bead and, based on the generated image, determining a parameter of the droplet. In some examples, determining a parameter of the droplet comprises comparing the generated image of the droplet to a previously generated image of the droplet. In some examples, analyzing the droplet comprises generating a composite image of the droplet on the surface of the cartridge, wherein the composite image comprises a plurality of images of the at least one paramagnetic, bar-coded bead of the droplet and, based on the generated composite image, determining a parameter of the droplet. In some examples, the method 600 includes transmitting instructions that cause a graphical user interface to display a graphical representation of the determined parameter of the droplet. In some examples, analyzing the droplet comprises performing a plurality of assay procedures on the droplet, and wherein, during the one or more assay procedures, determining the presence of one or more analytes adhered to the plurality of particles of the droplet, and wherein the plurality of particles comprises at least one paramagnetic, bar-coded bead.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A cartridge comprising:
a plurality of electrodes, wherein the plurality of electrodes comprises a first set of electrodes and a second set of electrodes;
a first surface for transporting, by applying a first electrical current to the first set of electrodes of the cartridge, a droplet on the first surface of the cartridge, wherein the first set of electrodes is configured to transport the droplet on the first surface of the cartridge along a path, and wherein the droplet comprises a plurality of particles; and
a second surface for manipulating, by applying a second electrical current to the second set of electrodes of the cartridge, the droplet on the second surface of the cartridge, wherein the second surface comprises an optical read window, and wherein the second set of electrodes circumscribes the optical read window.

2. The cartridge of claim 1, wherein the plurality of particles comprises at least one paramagnetic, bar-coded bead.

3. The cartridge of claim 2, wherein the at least one paramagnetic, bar-coded bead of the droplet comprises one or more unique bar codes.

4. The cartridge of claim 2, wherein the at least one paramagnetic, bar-coded bead of the droplet comprises at least one spherical, paramagnetic, bar-coded bead.

5. The cartridge of claim 2, wherein the at least one paramagnetic, bar-coded bead of the droplet is between approximately 0.1 to 100 microns in size.

6. The cartridge of claim 1, wherein at least one of the first and second surfaces of the cartridge comprises a dielectric material.

7. The cartridge of claim 1, wherein at least one of the first and second electrical currents comprises a direct electrical current.

8. The cartridge of claim 1, wherein the at least one of the first and second electrical currents comprises an alternating electrical current.

9. The cartridge of claim 1, wherein the optical read window of the cartridge comprises an optically transparent material.

10. The cartridge of claim 9, wherein the optically transparent material comprises one or more of: (i) polyethylene terephthalate (PET); (ii) polyethylene (PE); (ii) acrylic; (iv) glass; (v) polyvinyl chloride (PVC); (vi) polycarbonate (PC); (vii) silicone; and (viii) transparent rubber materials.

11. The cartridge of claim 10, wherein the optical read window of the cartridge further comprises a stiffening material.

12. The cartridge of claim 11, wherein the stiffening material comprises one or more of: (i) glass-reinforced epoxy resin laminate; (ii) polybutylene terephthalate (PBT); (iii) polyethylene terephthalate (PET); (iv) polyethylene (PE); (v) acrylic; (vi) glass; (vii) plastic; (viii) polyvinyl chloride (PVC); (ix) polycarbonate (PC); (x) metal; (xi) metal alloy; (xii) paper materials; (xiii) cardboard; (xiv) cellulose; and (xv) rubber materials.

13. The cartridge of claim 12, wherein the stiffening material circumscribes the optical read window.

14. The cartridge of claim 1, wherein the optical read window of the cartridge comprises a rounded optical read window.

15. The cartridge of claim 1, wherein the optical read window of the cartridge comprises a semi-rounded optical read window.

16. The cartridge of claim 1, wherein the second set of electrodes comprises a single electrode.

17. The cartridge of claim 1, wherein the second set of electrodes comprises two or more electrodes.

18. A method for analyzing a plurality of particles of a droplet on an optical read window of a cartridge, the method comprising:
transporting, by applying a first electrical current to a first set of electrodes of the cartridge, the droplet on a first surface of the cartridge, wherein the first set of electrodes is configured to transport the droplet on the first surface of the cartridge along a path, and wherein the droplet comprises the plurality of particles;
manipulating, by applying a second electrical current to a second set of electrodes of the cartridge, the droplet on a second surface of the cartridge, wherein the second surface comprises the optical read window, and wherein the second set of electrodes circumscribes the optical read window; and
analyzing the droplet while the droplet is manipulated on the second surface of the cartridge.

19. The method of claim 18, wherein analyzing the droplet comprises generating an image of the droplet on the second surface of the cartridge, wherein the generated image comprises an image of the plurality of particles of the droplet, and based on the generated image, determining a parameter of the droplet.

20. The method of claim 19, wherein analyzing the droplet further comprises, while generating an image of the droplet on the second surface of the cartridge, applying at least one of a fluorescent and brightfield light to the droplet.

21. The method of claim 20, wherein applying at least one of a fluorescent and brightfield light to the droplet comprises backlighting the droplet by applying at least one of a fluorescent and brightfield light to an opposing surface of the optical read window, wherein the opposing surface of the optical read window opposes the second surface of the cartridge.

22. The method of claim 20, wherein applying at least one of a fluorescent and brightfield light to the droplet comprises sidelighting the droplet by applying at least one of a fluorescent and brightfield light to the second surface of the cartridge.

23. A non-transitory computer-readable medium, having stored thereon program instructions that, upon execution by a controller, cause a controller to perform a set of operations comprising:
transporting, by applying a first electrical current to a first set of electrodes of a cartridge, on a first surface of the cartridge, wherein the first set of electrodes is configured to transport a droplet on the first surface of the cartridge along a path, and wherein the droplet comprises a plurality of particles;
manipulating, by applying a second electrical current to a second set of electrodes of the cartridge, the droplet on a second surface of the cartridge, wherein the second surface comprises an optical read window, and wherein the second set of electrodes circumscribes the optical read window; and
analyzing the droplet while the droplet is manipulated on the second surface of the cartridge.
